(19) United States
(12) Patent Application Publication
(10) Pub. No.: US 2025/0045768 A1
(43) Pub. Date: Feb. 6, 2025

(54) SYSTEM AND METHOD FOR PROVIDING ONLINE CUSTOMER SUPPORT

(71) Applicant: SHOPEE IP SINGAPORE PRIVATE LIMITED, Singapore (SG)

(72) Inventor: Chenglong CHEN, Shenzhen (CN)

(21) Appl. No.: 18/783,267

(22) Filed: Jul. 24, 2024

(30) Foreign Application Priority Data
Jul. 31, 2023 (SG) 10202302173W

(51) Int. Cl. G06Q 30/015; H04L 51/02

(52) U.S. Cl. CPC G06Q 30/015; H04L 51/02

(57) ABSTRACT

A system and method for implementing a customer support interface are disclosed. The method includes generating a customer support interface for a customer to engage in a chat session with a chatbot, wherein an option to engage in a chat session with a human agent is made unavailable on the customer support interface, receiving, by the chatbot, a first query from the customer, and determining, by the chatbot, a first reply to the first query. The first reply is generated for display on the customer support interface. After the first reply is generated, the method determines an overall probability that providing the customer with the option to engage in a chat session with a human agent would improve the likelihood of a positive outcome for the customer and determines whether the overall probability value satisfies a predetermined condition. Systems and machine-readable media are also provided.

### CROSS REFERENCE TO RELATED APPLICATIONS

This patent application claims the benefit and priority of Singaporean patent application number 10202302173W, filed with the Intellectual Property Office of Singapore on Jul. 31, 2023, entitled “SYSTEM AND METHOD FOR PROVIDING ONLINE CUSTOMER SUPPORT,” the contents of which are incorporated by reference in its entirety.

### FIELD OF THE INVENTION

The present invention generally relates to managing customer support resources and providing customer support. In particular, the present invention pertains to a system and method for implementing an online customer support interface.

### BACKGROUND

Live chat systems have become an integral communication tool for businesses to interact with online customers and resolve their queries or complaints in real-time. However, due to the high cost of employing customer service agents to provide live chat services, most businesses cannot afford to retain sufficient personnel round the clock to promptly attend to every customer using the live chat service at all times. This inevitably results in dissatisfaction among customers who experience long wait times for a customer service agent to be available to attend to them.

### SUMMARY OF INVENTION

According to a first aspect of the present invention, a method for implementing a customer support interface is disclosed. The method includes generating the customer support interface for a customer to engage in a chat session with a chatbot, wherein an option to engage in a chat session with a human agent is made unavailable on the customer support interface. The method further includes receiving, by the chatbot, a first query from the customer, and determining, by the chatbot, a first reply to the first query and generating the first reply for display on the customer support interface. After the first reply is generated, the method determines, using a prediction engine, an overall probability value that providing the customer with the option to engage in a chat session with a human agent would improve the likelihood of a positive outcome for the customer, and determines whether the overall probability value satisfies a predetermined condition. In response to determining that the overall probability value satisfies a predetermined condition, the method makes available on the customer support interface a selectable interface element representing the option to engage in a chat session with a human agent, wherein selecting the selectable interface element transfers the customer from the chat session with the chatbot to the chat session with the human agent.

According to some aspects of the subject technology, the method includes determining the overall probability value that providing the customer with the option to engage in a chat session with the human agent would improve the likelihood of a positive outcome for the customer comprises using the prediction engine to analyse one or more customer-associated feature data and calculating a first and a second conditional probability value, wherein the first conditional probability value is indicative of the likelihood of the positive outcome for the customer with human intervention, and the second conditional probability value is indicative of the likelihood of the positive outcome for the customer without human intervention. The method further includes calculating the overall probability value by subtracting the second conditional probability value from the first conditional probability value.

According to some aspects of the subject technology, the method includes analysing the one or more customer-associated feature data comprises analysing the first reply to determine a degree of validity of the first reply based on the first query.

According to some aspects of the subject technology, the prediction engine implements an uplift model to determine the overall probability value.

According to some aspects of the subject technology, the method includes determining whether the overall probability value satisfies a predetermined condition comprises determining whether the overall probability value is greater than a threshold value.

According to some aspects of the subject technology, the option to engage in a chat session with a human agent remains unavailable to the customer if the overall probability value is not greater than the threshold value.

According to some aspects of the subject technology, the option to engage in a chat session with a human agent is made unavailable on the customer support interface by visually hiding the selectable interface element from the customer.

According to some aspects of the subject technology, the option to engage in a chat session with a human agent is made unavailable on the customer support interface by disabling the selectable interface element.

According to some aspects of the subject technology, the first reply is displayed and the selectable interface element is made available on the customer support interface at the same time (or concurrently).

According to some aspects of the subject technology, the selectable interface element is made available on the customer support interface after or soon after the first reply is displayed.

According to some aspects of the subject technology, the selectable interface element is made available as part of the first reply.

According to some aspects of the subject technology, the method further includes executing a rule-based system prior to a start of the chat session to determine whether a live chat option is to be made available to the customer at the start of the chat session, and determining, using the rule-based system, that the option to engage in a chat session with a human agent is to be made unavailable on the customer support interface.

According to some aspects of the subject technology, the method further includes executing a rule-based system after the first reply is generated, wherein the rule-based system comprises a condition that depends on a number of interactions between the customer and the chatbot in the chat session.

According to some aspects of the subject technology, the rule-based system acquires data from a customer account database and/or a historical chat database.

According to some aspects, the present invention provides a system comprising one or more computers and one or more storage devices storing computer-readable instructions that, when executed by the one or more computers, cause the one or more computers to perform the steps of any of the above-described methods. The same applies to one or more non-transitory computer storage media storing instructions that, when executed by one or more computers, cause the one or more computers to perform the steps of any of the above-described methods. The method can thus be easily transferred to other systems and carried out there.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments, by way of example only, and to explain various principles and advantages in accordance with a present embodiment.

FIG. 1 shows a simplified diagram of a system for implementing an online customer support interface according to certain embodiments.

FIGS. 2a-2c show a flowchart of a method for implementing an online customer support interface according to certain embodiments.

FIGS. 3a-3c show an exemplary implementation of an online customer support interface according to certain embodiments.

Skilled artisans will appreciate that elements in the figures are illustrated for simplicity and clarity and have not necessarily been depicted to scale. For example, the dimensions of some of the elements in the block diagrams or steps in the flowcharts may be exaggerated relative to other elements to help improve understanding of the present embodiment.

### DETAILED DESCRIPTION

With the proliferation of artificial intelligence (AI) technologies, businesses are increasingly looking to supplement their live chat services with automated customer support systems managed by chatbots to reduce the demand for live chat services. Chatbots can be programmed to perform a myriad of tasks, from answering common questions to booking appointments. Chatbots help to reduce or deflect demand for live chat services by providing customers with self-service options to get answers, or perform simple transactions, without the need to interact with customer service agents.

Ideally, chatbots serve as a first level of customer engagement and support to deflect customers with simple queries (e.g., frequently asked questions) or basic requests (e.g., making a reservation) away from the live chat service, thereby allowing the customer service agents to focus on customers with complex queries that could not be adequately resolved by the chatbot. However, there are some drawbacks to customer service chatbots. In one example, chatbots lack understanding of human emotions and intent, and may not provide meaningful responses to a customer's query (e.g., question or request). In another example, the answers or replies that a chatbot can provide to a customer are generally limited by the information stored internally by the system to which the chatbot interfaces. If the stored information is insufficient, the chatbot may not be able to properly assist the customer. This can lead to customer frustration and dissatisfaction when interacting with chatbots. Thus, many customers opt to bypass chatbot interaction and directly engage a customer service agent via live chat services at the start of (or during) a chat session, regardless of whether their queries or requests can be resolved by the chatbot. This renders the chatbots ineffective for their intended purpose. Furthermore, this will put more stress on the customer service agents which are a limited resource. There is therefore a need to strike a balance in using chatbots and customer service agents to handle customer queries. Consequently, there is a need to minimize the number of interactions between customers and customer service agents without compromising the rate of positive outcomes for customers.

What is thus required are improved systems and/or methods for providing online customer support, which addresses the aforementioned problems by selectively hiding the live chat option at the start of an automated chat session, and selectively presenting (or revealing) the hidden live chat option only when it is predicted that human intervention will improve the likelihood of a positive outcome for the chat session, thereby optimizing the use of both the automated chatbot system and human agent resources. Furthermore, other desirable features and characteristics will become apparent from the subsequent detailed description and the appended claims, taken in conjunction with the accompanying drawings and this background of the disclosure.

The following detailed description is merely exemplary in nature and is not intended to limit the invention or the application and uses of the invention. Furthermore, there is no intention to be bound by any theory presented in the preceding background of the invention or the following detailed description.

It is the intent of certain embodiments to teach a system and method for implementing a customer support interface. The customer support interface can be provided by a commercial entity (e.g., an e-commerce platform, a financial services company, a gaming company, etc.) as a means of providing customer support to its online customers including, but not limited to, replying to customer queries or providing information to customers in real-time. The customer support interface is configured to receive a customer input query (e.g., question or request) from a customer who is seeking customer support from the commercial entity (e.g., a customer support request), and transmit the customer input query to an automated chatbot system for generating a response. For example, the customer support interface includes a chat feature that allows an online customer to enter a query, and a chatbot will provide a reply to the query.

In some embodiments, the chatbot is configured to initiate a conversation session (or chat session) with an online customer, while an option (e.g., live chat option) to transfer the customer's chat session to a customer service agent (hereinafter “human agent”) is withheld (i.e., made unavailable) from the customer, when the customer support interface is generated and displayed. Upon receiving a first customer input query from the customer, the chatbot generates a first reply (without human intervention) to the first customer input query for display on the customer support interface. After generating the first reply, the chatbot acquires a first input data set and feeds the first input data set to a prediction engine to determine an overall probability (or likelihood) that human intervention (e.g., assistance from a human agent) can improve the likelihood of a positive outcome for the customer. A positive outcome refers to, for example, the resolution of a customer's query. The prediction engine can take into account a degree of validity of the machine-generated first reply when determining the overall probability.

In some embodiments, when the prediction engine determines that the overall probability (that human intervention can improve the likelihood of a positive outcome for the customer) is greater than a threshold value, the option to transfer the customer to a human agent will be made available on the customer support interface. For example, the live chat option (by way of a selectable interface element) can be displayed simultaneously with the machine-generated reply, or soon after, or after the machine-generated reply has been displayed. At this point, if the customer is not satisfied with the machine-generated first reply, the customer is able to select the live chat option and be transferred to a human agent for further assistance.

In some embodiments, when the prediction engine determines that the overall probability (that human intervention can improve the likelihood of a positive outcome for the customer) is not greater than a threshold value, the option to transfer the customer (or the chat session) to a human agent will continue to be withheld from the customer. For example, the machine-generated first reply is displayed while the live chat option remains unavailable (e.g., hidden or disabled) on the customer support interface such that the customer is unable to select it. At this point, the customer may continue to interact with the chatbot by providing a second customer input query. The chatbot receives the second customer input query from the customer and generates a second reply (without human intervention) for display on the customer support interface. After generating the second reply, the chatbot acquires a second input data set and feeds the second input data set to the prediction engine to determine the overall probability (or likelihood) that human intervention can improve the likelihood of a positive outcome for the customer, and the cycle repeats each time the chatbot generates a reply to a corresponding query. The prediction engine can take into account a degree of validity of the machine-generated second reply when determining the overall probability.

By withholding the live chat option from the customer from the start of the chat session, the present invention prevents customers from bypassing the chatbot and ensures that the chatbot effectively functions as a first level of customer engagement and support while the limited human agent resource is conserved. At the same time, the present invention monitors the customer's interactions with the chatbot in real-time and uses those real-time interactions as input features to enrich the input dataset for the prediction engine to determine an overall probability that human intervention can improve the likelihood of a positive outcome for the customer. For example, the prediction engine can take into account a degree of validity of the machine-generated reply based on the corresponding customer input query during the process of determining the overall probability that human intervention can improve the likelihood of a positive outcome for the customer. The prediction engine is configured to selectively provide the live chat option only when the overall probability is greater than a threshold value or within a threshold range. As a result, the live chat option is only made available to select customers (or group of customers) when they are predicted to benefit the most from engaging with a human agent. This optimizes the allocation of available human agents, which is a limited resource and also increase the chance or rate of positive outcomes for the customers.

On the other hand, the live chat option is withheld from the other customers when they are predicted to have little or no benefit from engaging with a human agent, to encourage the other customers to interact with the chatbot to resolve their queries. As a result, the engagement rate (e.g., percentage of customers who interact with the chatbot) and deflection rate (e.g., percentage of customer queries that are resolved by the chatbot without any human intervention) of the chatbot is improved. Moreover, by configuring the live chat option to be displayed concurrently with (or soon after, or after) displaying the machine-generated reply, the machine-generated reply is given an opportunity to resolve the customer's query before the customer selects (or is presented with) the live chat option. This can further drive the deflection rate of the chatbot. The present invention also advantageously strikes a balance between increasing deflection rate and increasing customer satisfaction by running the prediction engine during the chat session to monitor the customer's interaction with the chatbot and dynamically determine the timing of when the live chat option should be offered to the customer (e.g., when it is predicted that human intervention can likely improve the outcome for the customer).

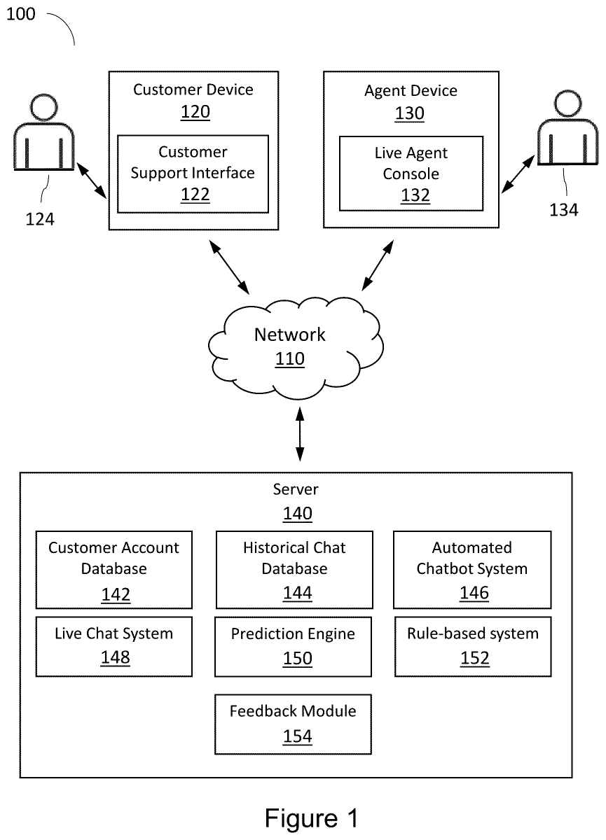

FIG. 1 shows a simplified diagram of a system 100 for implementing an online customer support interface according to certain embodiments. The system 100 may include one or more components, modules or layers, which may be implemented using software and/or hardware, optionally across multiple locations or using multiple devices or units. An overview of the system 100 is described in relation to FIG. 1. Thereafter, a more detailed description of the system 100 is provided in relation to remaining figures.

The system 100 may be implemented as a single system, multiple systems, distributed systems, or in any other form. Each component of the system 100 may be any type of computing device that is suitable for performing the functionality required by one or more embodiments of the present invention, and capable of communicating with each other directly or over a network 110. In some embodiments, the system 100 includes a customer device 120, an agent device 130, and a server 140 communicatively coupled to each other via the network 110.

The network 110 illustrated in FIG. 1 may include any number of suitable networks and/or network types. For example, the network 110 may include, but is not limited to, one or more of virtual private networks (VPNs), local area networks (LANs), wide area networks (WANs) such as the Internet, wireless WANS (WWANS), metropolitan area networks (MANs), Wi-Fi networks, WiMAX® networks, Bluetooth® communication networks, peer-to-peer networks, cellular telephone networks, or any combination of such networks. The network 110 can include any combination of connections (e.g., wired, wireless, or fiber optic connections) and protocols that will support communications between each component in the system 100 in accordance with one or more embodiments of the invention. For example, data transmitted by the network 110 may include packetized data, e.g., Internet Protocol (IP) data packets, that is routed to designated computing devices coupled to the network 110. The network 110 may include networking software and/or hardware that interconnects the computing devices of the system 100. For example, the network 110 may include packet-switching devices that route the data packets to the various computing devices based on information included in a header of the data packets.

The data exchanged over the network 110 can be represented using technologies and/or formats including the hypertext markup language (HTML), the extensible markup language (XML), JavaScript Object Notation (JSON), Comma Separated Values (CSV), Java DataBase Connectivity (JDBC), Open DataBase Connectivity (ODBC), etc. In addition, the data exchanged over the network can be encrypted using encryption technologies, for example, the secure sockets layer (SSL), Secure HTTP (HTTPS) and/or virtual private networks (VPNs) or Internet Protocol security (IPsec).

It should be appreciated that custom and/or dedicated data communications technologies instead of, or in addition to, the ones described above can also be used to perform the functionality required by one or more embodiments of the present invention.

The server 140 illustrated in FIG. 1 may take the form of one or more web-based server computers, such as a web server, an application server, a database server, etc., that are capable of communicating with the customer device 120 and agent device 130 over the network 110. For example, the server 140 may be embodied in a single server computer, or distributed as a plurality of interconnected server computers, and operate in a cloud computing environment. The server 140 can include a processor and a memory. A memory may be volatile or non-volatile types of non-transitory computer-readable media, such as magnetic media, optical media, random access memory (RAM), read-only memory (ROM), removable media, or any other suitable local or remote memory unit. The memory can include digital data that can be accessed by the processor. A processor may be any type of device, or multiple devices, capable of manipulating or processing information from a non-transitory computer-readable media (e.g., a memory). For example, a processor includes a central processing unit (CPU) for processing computer-executable program instructions to perform one or more processes.

The server 140 can include one or more storage devices storing data structures and/or computer instructions for execution by the processor. For example, the server 140 can include one or more computer-readable data stores to support the functionality required by one or more embodiments of the invention. Various types of computing devices may be employed for the server 140. For example, the computer may be a mainframe, a workstation, as well as other types of processing devices. The memory may include digital data that can be accessed by the processor. The server 140 and/or data store may be coupled with various databases or storage devices in the form of any suitable computer readable medium, such as a hard disc drive, a memory device, a flash drive or an optical drive.

In some embodiments, an e-commerce platform (not shown) may be implemented wholly or partially on the server 140. The e-commerce platform may provide merchants with online resources and facilities for managing their business. Merchants may utilize the e-commerce platform for managing commerce with customers, such as by implementing an e-commerce experience with customers through an online store. An online store may refer to the multitenant collection of storefronts supported by the e-commerce platform (e.g., for a plurality of merchants) or to an individual merchant's storefront (e.g., a merchant's online store). For example, the server 140 can support a single integrated website (also referred to as a multi-merchant website), which functions as a virtual shopping mall. In some embodiments, the e-commerce platform provides customers with online customer support, such as by implementing an automated chatbot system and a live chat system. In some embodiments, the online stores are served by the e-commerce platform to customers who have registered an account with the e-commerce platform as will be described in more detail below.

The customer device 120 illustrated in FIG. 1 is representative of any number of customer devices that can be included in the system 100. Each customer device 120 is a computing device having data processing and communication capabilities. In some embodiments, a customer device 120 may include a processor (e.g., CPU), a memory (e.g., RAM, ROM, etc.), a power source, a network interface, and/or other software and/or hardware components, such as a display, graphics processor, wireless transceivers, keyboard, speakers, camera, sensors, firmware, operating systems, drivers, various physical connection interfaces (e.g., USB, HDMI, etc.). For example, the customer device 120 may take the form of one or more personal computers, tablet computers, smart phones, home entertainment computers, network computing devices, mobile computing device, personal digital assistants, virtual machines, servers, other computing devices, or any combination of such computing devices.

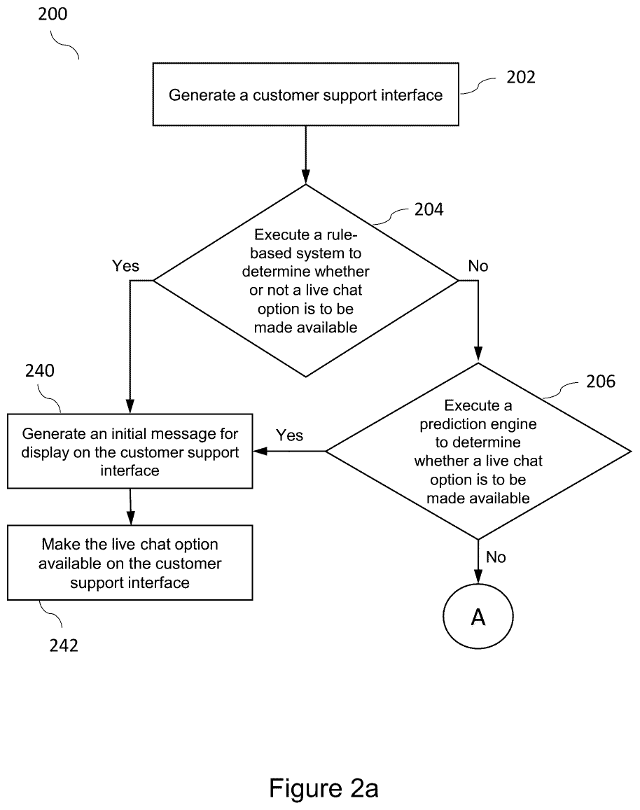

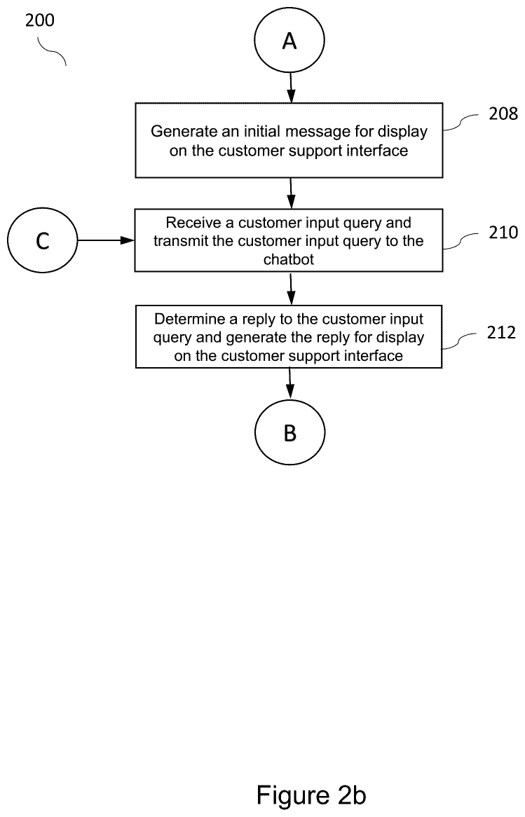

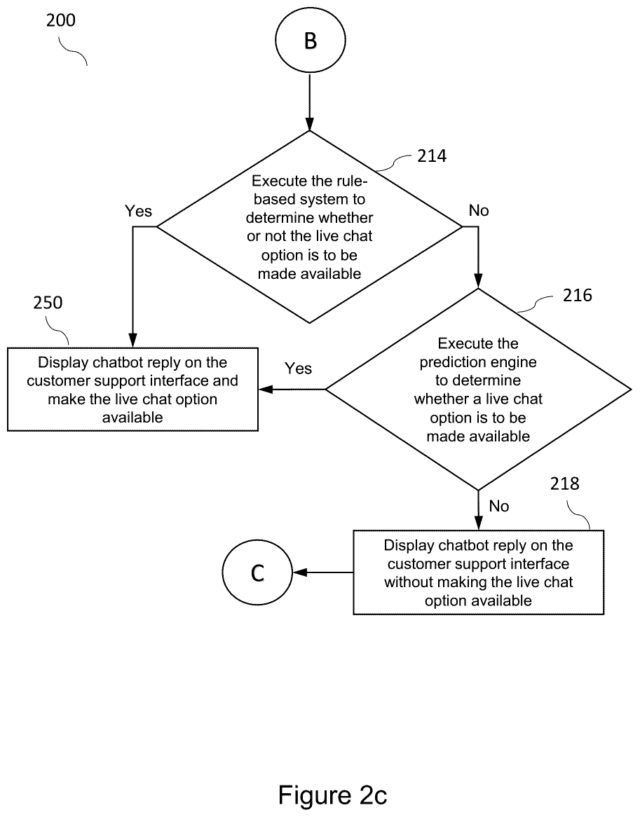

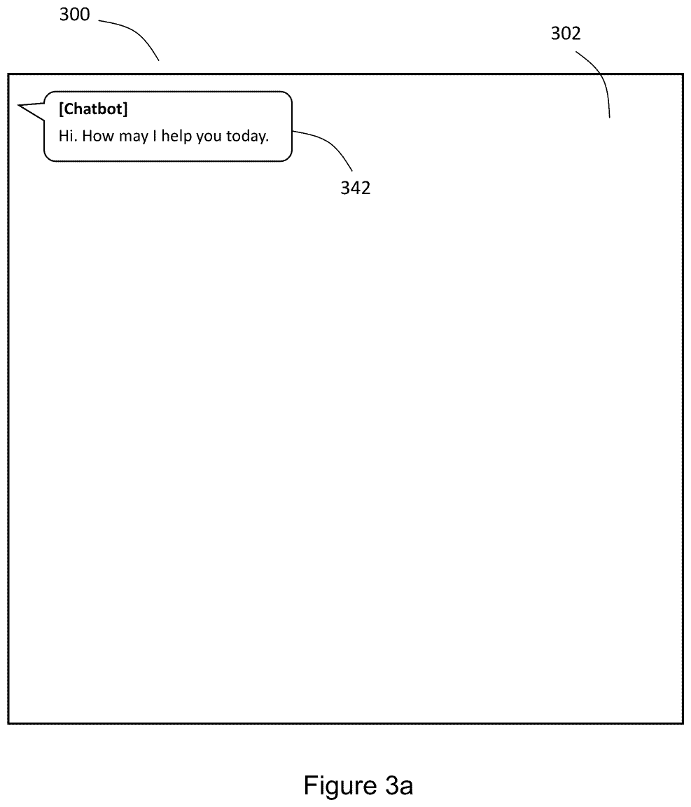

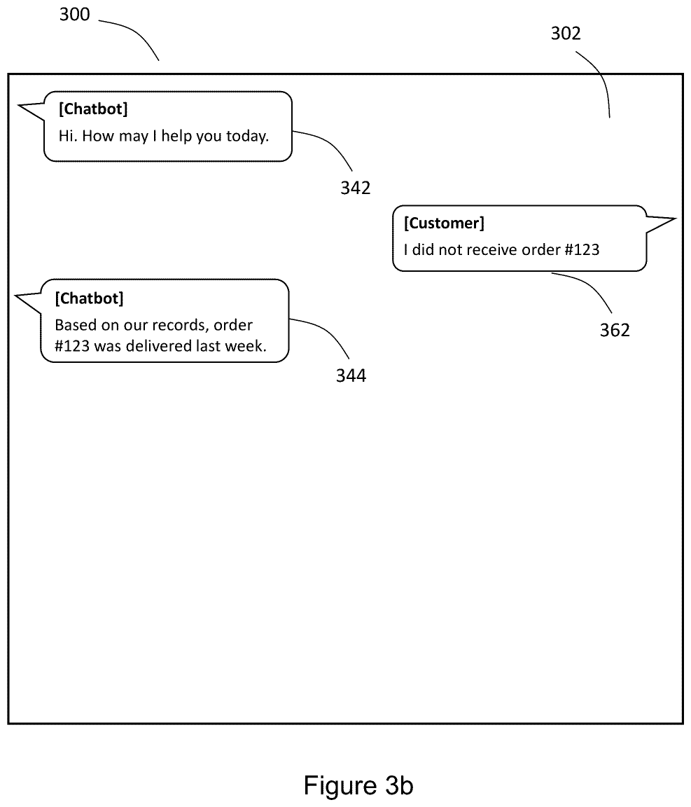

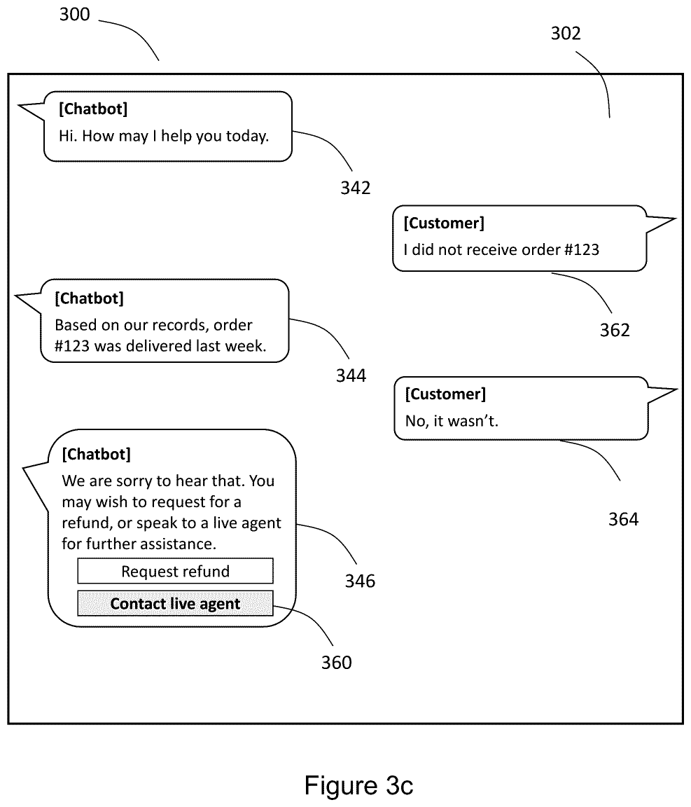

In some embodiments, a customer device 120 may be associated with a customer 124 of the e-commerce platform. For example, the customer 124 may have a customer account registered with the e-commerce platform. A customer 124 interacts (or interfaces) with the system 100 using the customer device 120 associated with the particular customer. The customer 124 illustrated in FIG. 1 is representative of any number of customers that can be included in the system 100. The customer device 120 includes a display for displaying a customer support interface 122 as described further herein and with regard to FIGS. 2a-2c and FIGS. 3a-3c.

The agent device 130 illustrated in FIG. 1 is representative of any number of agent devices that can be included in the system 100. Each agent device 130 is a computing device having data processing and communication capabilities. In some embodiments, an agent device 130 may include a processor (e.g., virtual, physical, etc.), a memory, a power source, a network interface, and/or other software and/or hardware components, such as a display, graphics processor, wireless transceivers, keyboard, speakers, camera, sensors, firmware, operating systems, drivers, various physical connection interfaces (e.g., USB, HDMI, etc.). For example, the agent device 130 may take the form of one or more personal computers, tablet computers, smart phones, home entertainment computers, network computing devices, mobile computing device, personal digital assistants, virtual machines, servers, other computing devices, or any combination of such computing devices.

In some embodiments, an agent device 130 may be associated with a human customer service agent (or human agent) 134 employed by the e-commerce platform. For example, the human agent 134 operates a live chat service offered to customers 124 of the e-commerce platform. A human agent 134 interacts (or interfaces) with the system 100 using the agent device 130 associated with the particular human agent. The human agent 134 illustrated in FIG. 1 is representative of any number of human agents that can be included in the system 100. The agent device 130 includes a display for displaying a live agent console 132. The live agent console 132 provides an interface for the human agent 134 to communicate with a customer 124. For example, the live agent console 132 can be communicatively coupled to the customer support interface 122 via the network 110.

The server 140 can include a customer account database 142, a historical chat database 144, an automated chatbot system 146, a live chat system 148, a prediction engine 150, a rule-based system 152, and a feedback module 154. The customer account database 142 and the historical chat database 144 and are both data stores that store previously obtained data. The customer account database 142 stores information and attributes of each registered customer 124 (i.e., customers who have registered an account with the e-commerce platform) including, but not limited to, age, gender, race, nationality, email, purchase history, product interests, residential address, geographic location, and any other information corresponding to a customer 124. For example, the information and attributes of each customer 124 stored in the customer account database 142 may be acquired from the process of registering an account on the e-commerce platform, from the registered customers' 124 activity on the e-commerce platform, and from tracing the customer's 124 IP address.

The historical chat database 144 stores previous chat transcripts of the conversations between each registered customer 124 and the chatbot and/or human agent 134 from the chat sessions conducted on the customer support interface 122. The historical chat database 144 can counts the number of past chat sessions conducted for each registered customer 124. The historic chat database 144 can receive and store customer feedback and human agent feedback associated with each chat session. For example, the customer feedback and human agent feedback are transmitted to the historic chat database 144 from the feedback module 154.

The automated chatbot system 146 provides a chatbot and a graphical user interface for customers 124 to communicate with the chatbot and/or a human agent 134. For example, the automated chatbot system 146 can receive customer inputs (e.g., text messages) transmitted from the customer device 120 and agent device 130, and displays the customer input queries on the graphical user interface. The automated chatbot system 146 also transmits customer inputs received from the customer device 120 to the chatbot, and then receives a corresponding machine-generated response (without human intervention) from the chatbot for display on the graphical user interface. The graphical user interface is, for example, the customer support interface 122 as described further herein and with regard to FIGS. 2a-2c and FIGS. 3a-3c. The automated chatbot system 146 determines whether a customer input is part of a new conversation session or whether it is part of an existing conversation session. The automated chatbot system 146 determines if the conversation session is completed based on a completion signal (e.g., interface window closed) from the customer device 120 and/or agent device 130.

The chatbot is an automated computer program which conducts a conversation via auditory or textual methods. The chatbot is configured to simulate how a human would behave as a conversational partner. The chatbot receives a text message from the customer device 120 and parses for keywords or phrases within the text message and/or determines the topic and intent of the text message using natural language processing. The chatbot then generates a reply based on the identified topic and intent. The chatbot then transmits the generated response to the automated chatbot system 146 for display on the customer support interface 122. In some embodiments, after generating the response, the chatbot is configured to acquire an input data set, which includes the generated response, and feed the input data set to the prediction engine 150 to determine whether an option to engage in a chat session with a human agent 134 should be made available to the customer 124. Based on the determination by the prediction engine 150, the automated chatbot system 146 then determines whether the option to engage in a chat session with a human agent 134 should be made available to the customer 124 as will be described in more detail below.

The live chat system 148 may be configured to communicatively connect a customer 124 with a human agent 134 for interaction in real-time (e.g., a live chat). The live chat system 148 may receive a request from the automated chatbot system 148 to initiate a live chat between the customer 124 of the customer device 120 and a live agent 134. The request for a live chat may include customer information (e.g., customer name, email address, internet protocol (IP) address, etc.), information regarding a type of service requested for the live chat (e.g., service related to an account, purchasing, pending orders, technical questions, etc.) and a history of the conversation dialogue between the customer 124 and the chatbot. For example, the live chat may be initiated during an existing chat session with the chatbot, and the request includes a history of the interactions between the customer 124 and the chatbot in that existing chat session.

The prediction engine 150 includes a program or algorithm (e.g., machine learning algorithm) for, when executed by the system 100, automatically processes the input data set given by the chatbot to determine an overall probability that providing the live chat option (or human intervention) would improve the likelihood of a positive outcome for the customer 124 (e.g., resolution of a customer's query). The input data set for the prediction engine 150 may include the latest machine-generated reply (or chatbot reply) and the corresponding customer query. In some embodiments, the prediction engine 150 is configured to process the machine-generated reply included in the input data set and determine a degree of validity of the reply based on the corresponding query. The determined degree of validity of the reply is then used as feature data alongside one or more other feature data in the input data set for the prediction engine 150 to determine the overall probability. The other feature data includes, for example, information and attributes stored in the customer account database and/or historical chat database that is associated with the specific customer 124.

The prediction engine 150 can implement an uplift model. The uplift model may be defined by the following equation:

$$\frac{P ( {Y}_{i} = 1 , {W}_{i} = 1 \vert {X}_{i} )}{P ( {W}_{i} = 1 \vert {X}_{i} )} - \frac{P ( {Y}_{i} = 1 , {W}_{i} = 0 \vert {X}_{i} )}{P ( {W}_{i} = 0 \vert {X}_{i} )} ,$$

where P denotes a probability value, i denotes a particular customer, Yᵢ=1 denotes customer i giving a positive feedback (e.g., via the feedback module 154) at the end of a chat session, Wᵢ=1 denotes customer i receiving the treatment (e.g., making the live chat option available to customer i), Wᵢ=0 denotes customer i receiving no treatment (e.g., making the live chat option unavailable to customer i), Xᵢ denotes the vector of variables associated with customer i (e.g., feature data stored in the customer account database 142 and/or historical chat database 144 that is associated with customer i), P(Wᵢ=1|Xᵢ) denotes the probability of treatment given Xᵢ, P(Wᵢ=0|Xᵢ), denotes the probability of no treatment given Xᵢ, P(Yᵢ=1, Wᵢ=1|Xᵢ)/P(Wᵢ=1|Xᵢ) denotes the conditional probability that customer i will give a positive feedback if the live chat option is made available to customer i given Xᵢ, and P(Yᵢ=1, Wᵢ=0|Xᵢ)/P(Wᵢ=0|Xᵢ) denotes the conditional probability that customer i will give a positive feedback if the live chat option is made unavailable to customer i given Xᵢ.

In some embodiments, the prediction engine utilizes the uplift model to process the plurality of feature data in the input data set, including the determined degree of validity of the chatbot reply, to determine the overall probability that human intervention would improve the likelihood of a positive outcome for the customer 124. For example, if the overall probability satisfies a predetermined condition (e.g., exceeds a threshold or within a threshold range), the prediction engine 150 will determine that there is a high likelihood that the customer's outcome will be uplifted with human intervention. The term “uplift” refers to the increased chance of a positive outcome for the customer with human intervention as compared to the chance of a positive outcome for the customer without human intervention.

The rule-based system 152 applies predefined rules to determine whether the live chat option should be made available to the customer 124. For example, the rule-based system 152 is communicatively coupled to the automated chatbot system 146. The rule-based system 152 may be executed before and/or after the start of the chat session to determine whether the predefined rules are satisfied. A rule generally comprises one or more conditions and one or more actions to be taken if the conditions are satisfied. It should be understood that the rules may include multiple conditions with potentially complicated inter-relationships among the conditions. The predefined rules may include making the live chat option available to only a select group of customers 124. For example, the rule-based system 152 may identify customers 124 who have expressed dissatisfaction (e.g., given negative feedback) with the chatbot interaction in previous chat sessions, and make the live chat option available to the identified customers 124 to improve the likelihood of a positive outcome for these customers 124. Other implementations of the rule-based system 152 may also be useful. In some embodiments, the rule-based system 152 is configured to be executed before and after the start of the chat session as will be described in more detail below. For example, the rule-based system 152 can be executed one or more times during the chat session.

The feedback module 154 is configured to solicit feedback from the customer 124 when a chat session ends. In some embodiments, the feedback module 154 generates a rating interface (not shown) at the end of a chat session and displays the rating interface on the customer device 120. The rating interface may include any suitable rating options for rating the particular chat session. Customers 124 can operate the rating options or scale on the rating interface to provide feedback on, for example, the interaction with the chatbot or the human agent 132. The results from the feedback are stored in the historical chat database 144 for future use in the processes as described further herein. For example, the feedback results can be supplied to the rule-based system 152 and/or the prediction engine 150 to determine whether or not the live chat option should be made available to the customers 124.

It should be understood that the system 100 illustrated in FIG. 1 is representative of an exemplary system according to one or more embodiments and that a variety of different system environments and configurations are contemplated and are within the scope of the present disclosure. Furthermore, the system 100 may include automatic speech recognition (ASR) functionality (not shown), which may enable verbal/voice input (e.g., via VOIP) and/or requests, and text-to-speech (TTS) functionality, which may enable, verbal output by the system 100 to an end-user (or user) of the system 100, such as the human agent 134 or the customer 124. However, it should be recognized that customer inputs may use text and the system 100 may provide outputs via text.

FIGS. 2a-2c show a flowchart describing a method 200 for implementing an online customer support interface 122 according to certain embodiments. The method 200 is explained in conjunction with the system 100 as described earlier through the previous figure of the disclosure and same or similar processes and elements may not be described in detail. The steps identified in FIGS. 2a-2c are exemplary and may include various alternatives, equivalents, or derivations thereof including but not limited to the order of execution of the same. The steps of FIGS. 2a-2c (and its various alternatives) may be embodied in hardware or software including a computer-readable storage medium including instructions executable by the likes of a processor in a computing device.

In step 202, the method generates a customer support interface 122. The customer support interface 122 may be provided by a commercial entity as a means of providing assistance to its online customers. For example, a customer 124 can initiate the customer support interface 122 from a web browser or other application installed on the associated customer device 120, where the web browser (or other application) connects to an automated chatbot system 146 associated with the commercial entity through an IP Address. In some embodiments, the customer support interface 122 may be provided on an e-commerce platform accessed by a customer device 120 of a customer 124. The customer support interface 122 may include or represent an interface window of an automated chatbot system 146. For example, the customer support interface 122 may be configured to be an overlay window (or floating window) on a portion of a web page of a website. Alternatively, the customer support interface 122 may be provided by a frontend system installed on the customer device 120, such as a mobile application. For example, the customer support interface 122 may be configured to be a page (e.g., customer support page) within the mobile application. The automated chatbot system 146 hosts a chatbot configured to generate an automated conversational dialog with the customer via the customer support interface 122, and to receive customer input query from the customer device 120 via the customer support interface 122, responsive to the automated conversational dialog.

In step 204, the method executes a rule-based system 152 to determine whether or not a live chat option is to be made available. For example, the rule-based system 152 can be executed before the start of a chat session to determine whether or not the live chat option is to be made available to the customer 124 on the customer support interface 122 at the start of the particular chat session. In some embodiments, the rules used by the rule-based system 152 can include, but is not limited to, a pre-defined set of conditional rules, rules learned based on customer behaviour and attributes, or a combination thereof. For example, one or more rules can be learned based on customer behaviour data and/or customer attribute data acquired from the customer account database 142, the historical chat database 144, and the automated chatbot system 146.

To illustrate an exemplary rule-based system 152, a first rule can include the condition that if, according to the data in the historical chat database 144 and the customer account database 142, the customer 124 is new to the customer support interface 122 or has a low chatbot usage rate (or low contact frequency with the chatbot), then it is determined that the live chat option is not to be made available on the customer support interface 122 to encourage the customer 124 to interact or increase interaction with the chatbot. A second rule can include the condition that if, according to the data in the customer account database 142, the customer 124 is in a relatively high tier of a tiered loyalty program (e.g., top loyalty tier), then it is determined that the live chat option is to be made available on the customer support interface 122 as a reward offered by the loyalty program. A third rule can include the condition that if the customer 124 has interacted with the chatbot a predefined number of times within the same chat session, then it is determined that the live chat option is to be made available on the customer support interface 122 to provide the customer 124 with the option to interact with a human agent 134 as the customer 124 has not received adequate assistance from the chatbot (e.g., to pre-empt the customer from abandoning the chat session due to the lack of human assistance). Other similar rules containing any number of conditions that depend on customer behaviour and/or customer attribute data acquired from the historical chat database 144 and the customer account database 142 to cause the method to determine whether or not a live chat option is to be made available on the customer support interface 122. Additionally, in some embodiments, if none of the rules used by the rule-based system 152 is satisfied (e.g., evaluate to being true), a default determination that the live chat option is not to be made available on the customer support interface 122 can be made.

In some embodiments, the method proceeds from step 204 to step 240 when it is determined that the live chat option should be made available to the customer 124 at the start of a chat session.

In step 240, the method generates an initial message for display on the customer support interface 122. The initial message is generated by the chatbot and displayed on the customer support interface 122 to engage the customer 124 in an electronic conversation and mark the start of the chat session. The initial message is, for example, welcome message. The method continues to step 242.

In step 242, the method makes the live chat option available on the customer support interface 122. The live chat option may be represented by a selectable interface element positioned on the customer support interface 122. For example, the live chat option may a selectable interface element presented by way of a chatbot message. In another example, the live chat option may be displayed as a selectable interface element occupying a dedicated position on the customer support interface 122. The customer 124 is able to select the live chat option (e.g., select a ‘Contact live agent’ option represented by a selectable interface element) to engage in a chat session with a human agent 134.

In some embodiments, the live chat option is made available at the same time as when the initial message is displayed on the customer support interface 122. For example, the initial message can include the live chat option as part of the message. In some alternative embodiments, the live chat option is made available after (e.g., soon after) the initial message is displayed on the customer support interface 122. For example, the live chat option does not form part of the initial message. The initial message serves to encourage the customer 124 to communicate with the chatbot instead of using the available live chat option. The customer 124 is thus given the choice to either interact with the chatbot or interact with a human agent 134 via the live chat option at the start of the chat session.

In other embodiments, the method proceeds from step 204 to step 206 when it is determined that the live chat option should not be made available to the customer 124 at the start of a chat session. The live chat option may be represented by a selectable interface element positioned on the customer support interface 122. For example, if the live chat option is a selectable interface element presented by way of a chatbot message, the live chat option can be made unavailable by omitting the live chat option from the chatbot message (e.g., the welcome message). In another example, if the live chat option is a selectable interface element occupying a dedicated position on the customer support interface 122, the live chat option can be made unavailable by visually hiding the selectable interface element, or by disabling the selectable interface element (e.g., the selectable interface element is greyed out to indicate that it is in an inoperative/disabled state).

In step 206, the method executes a prediction engine 150 to determine whether a live chat option is to be made available. For example, the prediction engine 150 can be executed before the start of a chat session, and in sequence with the rule-based system 152, to determine whether the live chat option is to be made available to the customer 124 on the customer support interface 122 at the start of the particular chat session. In some embodiments, after the customer support interface 122 is generated, the chatbot acquires an initial input data set for the prediction engine 150 and feeds the initial input data set to the prediction engine 150. The initial input data set can include customer behaviour data and/or customer attribute data acquired from the historical chat database 144 and the customer account database 142. The method utilizes the prediction engine 150 to determine an overall probability or likelihood that providing the customer 124 with the live chat option would improve the likelihood of a positive outcome for the customer 124.

In some embodiments, the prediction engine 150 utilizes an uplift model to process a plurality of feature data in a given input data set (e.g., the initial input data set) and calculate a first and second conditional probability to determine the overall probability value that human intervention (e.g., assistance from the human agent 134) would improve the likelihood of a positive outcome for the customer 124. For example, the first conditional probability is indicative of the likelihood that a customer's query will be resolved with human intervention, and the second conditional probability is indicative of the likelihood that the customer's query will be resolved without human intervention. The overall probability value is calculated by subtracting the second conditional probability value from the first conditional probability value. In some embodiments, it is determined that human intervention would improve the likelihood of a positive outcome for the customer 124 when the overall probability value satisfies a predetermined condition (e.g., exceeds a threshold value). The overall probability may represent an estimated uplift value for the customer 124 as a result of receiving assistance from a human agent 134.

A probability value may be a value between 0 and 1, where I indicates that the given outcome is predicted to occur and 0 indicates that the given outcome is predicted not to occur. For example, a higher probability value indicates a greater likelihood for the outcome to occur and a lower probability value indicates a lesser likelihood for the outcome to occur. In this case, the predetermined condition is that the overall probability value (or estimated uplift value) exceeds a threshold value of 0. In some exemplary implementations, when the first conditional probability value is 0.7 and the second conditional probability value is 0.3, the overall probability value equals 0.4 and the predetermined condition is satisfied; when the first conditional probability value is 0.5 and the second conditional probability value is 0.8, the overall probability value equals −0.3 and the predetermined condition is not satisfied; when the first conditional probability value is the same as the second conditional probability value, the overall probability value equals 0 and the predetermined condition is not satisfied.

Table 1 below is offered to illustrate the calculation of an overall probability value using the aforementioned exemplary implementations, but not to limit the present invention. Referring to Table 1, the leftmost column shows exemplary customers, the second column from the left show exemplary first conditional probability values associated with the customers, the third column from the left show exemplary second conditional probability values with the customers, and the rightmost column show the overall probability values calculated based on the corresponding first and second conditional probability values.

TABLE 1
Exemplary calculation of an overall probability value

| | Probability of a | Probability of a | |
|---|---|---|---|
| | positive outcome | positive outcome | |
| | (with human | (without human | Overall |
| Customer | intervention) | intervention) | probability |
| 1 | 0.7 | 0.3 | 0.4 |
| 2 | 0.5 | 0.8 | −0.3 |
| 3 | 0.6 | 0.6 | 0 |

Although the method is described as executing steps 204 and 206 separately, it is understood that the method may also be configured to incorporate step 204 into step 206. For example, the rule-based system 152 can be incorporated within the prediction engine 150. In one alternative embodiment, the prediction engine 150 implements the rule-based system 152 and the uplift model in sequence to determine whether the live chat option is to be made available on the customer support interface 122. For example, the prediction engine 150 first implements the rule-based system 152 to make the determination, and if the rule-based system 152 determines that the live chat option is not to be made available on the customer support interface 122, the method continues by implementing the uplift model to make the determination.

In some embodiments, the method proceeds from step 206 to step 240 when the prediction engine 150 determines that the overall probability value satisfies the predetermined condition (e.g., the overall probability value is greater than the threshold value of 0). For example, based on the overall probability value, it is predicted that human intervention will improve the likelihood of a positive outcome for the customer 124.

In other embodiments, the method proceeds from step 206 to step 208 when the prediction engine 150 determines that the overall probability value does not satisfy the predetermined condition (e.g., the overall probability value is less than or equal to the threshold value of 0). For example, based on the overall probability value, it is predicted that human intervention will not improve the likelihood of a positive outcome for the customer 124.

Proceeding further to step 208, the method generates an initial message for display on the customer support interface 122. For example, the initial message is generated by the chatbot and displayed on the customer support interface 122 at the customer device 120 to engage the customer 124 in electronic conversation and mark the start of the chat session. In some embodiments, the chatbot's initial message is a welcome message for initiating a dialogue with the customer 124. The initial message can be, for example, “Hi there. How can I help”. Other suitable messages for initiating a dialogue with the customer 124 may also be useful. In step 208, since the live chat option is made unavailable on the customer support interface (e.g., the initial message does not include a live chat option), the customer 124 is not able to bypass the chatbot by requesting to chat with a human agent 134, and is compelled to interact with the chatbot for customer support services.

It is appreciated that the chatbot's initial message may also be configured to include one or more selectable chatbot options representative of commonly asked questions or requests to facilitate interaction with the customer 124.

In step 210, the method receives a customer input query and transmits the customer input query to the chatbot. In some embodiments, the chatbot includes a natural language processing (NLP) system. The NLP system may be configured to perform semantic processing on the customer input query (e.g., a message) received from the customer device 120 to determine a meaning or context of the customer input query. The semantic processing may receive as inputs any relevant information including, but not limited to, text of a message from the customer 124, information about the customer 124 (e.g., an IP address, a customer's gender, information about the Entry Point from which the customer initiated the customer support interface 122), or a customer identification. In some implementations, information from servers of the e-commerce platform may be used during the semantic processing, such as information about the customer 124 or information about the e-commerce platform's services (e.g., promotional campaigns). Semantic processing may be used to select an intent of the customer's 124 input query from a specified set of intents. For example, the chatbot may be configured with a set of intents relating to services provided by the e-commerce platform, such as technical support, shipping status, or frequently asked questions related to products or services.

In step 212, the method determines a reply to the customer input query and generates the reply for display on the customer support interface 122. In some embodiments, after the chatbot receives the customer's 124 input query, semantic processing is used to understand the meaning of the customer's 124 input query and a machine-generated reply is generated thereafter. For example, the chatbot generates relevant information, available actions and/or options for display on the customer support interface 122. In one exemplary chatbot interaction, the customer's 124 first input query is a question or request and the chatbot provides a first reply (without human intervention) that immediately resolves the customer's 124 first input query. In another exemplary chatbot interaction, more information is needed from the customer 124 and the machine-generated first reply asks the customer 124 to provide additional information. The replies (or responses) that a chatbot can provide to a customer 124 may be limited by the information stored in the system 100. If the stored information is insufficient, the chatbot may not be able to provide a sufficiently valid response to provide the customer 124 with a positive outcome (e.g., resolving the customer's query). The method continues to step 214.

In step 214, the method executes the rule-based system 152 to determine whether or not the live chat option is to be made available. For example, the rule-based system 152 can be executed before and after the start of a chat session to determine whether or not the live chat option is to be made available to the customer 124 on the customer support interface 122 at the start of or during the particular chat session. As described herein (e.g., in step 204), the rule-based system 152 can include the condition that if the customer 124 has interacted with the chatbot a predefined number of times within the same chat session, then it is determined that the live chat option is to be made available on the customer support interface 122 to provide the customer 124 with the option to interact with a human agent 134. In some embodiments, the automated chatbot system 146 is configured to update a chatbot interaction counter to monitor the number of interactions between the chatbot and the customer 124 within a same chat session. The term “interaction” refers to a query-reply pair. For example, a counter value of the chatbot interaction counter is instantly or near-instantly increased by 1 each time the chatbot generates a reply to a customer input query in a chat session.

In some embodiments, the rule-based system 152 determines, at step 214, whether the counter value of the chatbot interaction counter reaches an interaction threshold value (e.g., “5”). For example, after the chatbot interaction counter is updated, the rule-based system 152 determines whether or not the counter value of the chatbot interaction counter has reached (e.g., is equal to or more than) the interaction threshold value. In some embodiments, the method proceeds from step 214 to step 250 when it is determined that the live chat option is to be made available (e.g., the counter value of the chatbot interaction counter has reached the interaction threshold value).

In step 250, the method displays the chatbot reply and a live chat option on the customer support interface 122. In one embodiment, the machine-generated reply and the live chat option are displayed simultaneously on the customer support interface 122. For example, the live chat option is displayed as part of the machine-generated reply. In another example, the live chat option may be displayed as a selectable interface element occupying a dedicated position on the customer support interface 122. In an alternative embodiment, the live chat option is made available after a short delay period (e.g., 2 or 3 seconds after) from the time the machine-generated reply is displayed. For example, the live chat option is displayed in the form of a message on the customer support interface 122 soon after (e.g., 1, 2 or 3 seconds after) displaying the machine-generated reply. Displaying the live chat option after a short delay period from the time the machine-generated reply is displayed advantageously encourages the customer to consider whether the machine-generated reply has resolved the query, such as when the machine-generated reply presents two or more possible options (or solutions) responsive to the customer's query, before the live chat option is selected. This can help to further improve the deflection rate of the chatbot and conserve on the limited human agent 134 resource).

In other embodiments, the method proceeds from step 214 to step 216 when it is determined that the live chat option is not to be made available (e.g., the counter value of the chatbot interaction counter is less than the interaction threshold value).

In step 216, the method executes the prediction engine 150 to determine whether a live chat option is to be made available. For example, the prediction engine 150 can be executed before and after the start of a chat session, and in sequence with the rule-based system 152, to determine whether the live chat option is to be made available to the customer 124 on the customer support interface 122 at the start of or during the particular chat session. In some embodiments, after generating a reply to a customer's 124 input query, the chatbot acquires an input data set (e.g., first input data set) for the prediction engine 150 and feeds the input data set to the prediction engine 150. The input data set can include the latest generated reply and its corresponding query. The method utilizes the prediction engine 150 to determine an overall probability or likelihood that human intervention would improve the likelihood of a positive outcome for the customer 124.

In some embodiments, the prediction engine 150 analyses the chatbot reply to determine a degree of validity of the reply based on its corresponding customer input query. For example, the prediction engine 150 compares a reply with the corresponding query to determine a degree of semantic matching between the reply provided by the chatbot and the corresponding customer query (e.g., based on a sematic analysis of the query and the reply). In one exemplary scenario, the degree of validity may be high when the customer 124 submits a query to check the status of an order, where the query may be: “What is the status of Order #123?”, and the chatbot reply includes the status of the order, where the chatbot reply may be “Order #123 is out for delivery”. In another exemplary scenario, the degree of validity may be low when the customer 124 submits a query to dispute the status of an online order, where the query may be: “The status of Order #123 shows as delivered, but I never received it”, and the chatbot reply includes a suggested action not mentioned in the query, where the chatbot reply may be “You may wish to request for a refund”. The determined degree of validity of the reply is then used as a feature data alongside one or more other feature data in the input data set for processing by the prediction engine 150.

In some embodiments, the prediction engine 150 utilizes an uplift model to process the plurality of feature data in the given input data set (e.g., the first input data set) and calculate a first and second conditional probability to determine the overall probability value that human intervention (e.g., assistance from human agent 134) would improve the likelihood of a positive outcome for the customer 124, as described in step 206. For example, if the prediction engine has determined a degree of validity of a machine-generated first reply based on its corresponding first input query in step 216, the calculated overall probability value takes into account the determined degree of validity of the machine-generated first reply. For example, a high degree of validity (e.g., within an upper threshold range) can increase the overall probability value and a low degree of validity (e.g., within a lower threshold range) can decrease the overall probability value.

Although the method is described as executing steps 214 and 216 separately, it is understood that the method may also be configured to incorporate step 214 into step 216. For example, the rule-based system 152 can be incorporated within the prediction engine 150. In this case, the prediction engine 150 can be configured to first implement the rule-based system 152, and if the rule-based system 152 determines that the live chat option is not to be made available on the customer support interface 122, the method continues by implementing the prediction engine (e.g., the uplift model) to determine whether the live chat option is to be made available on the customer support interface 122.

In some embodiments, the method proceeds from step 216 to step 250 when the prediction engine 150 determines that the live chat option is to be made available. For example, the overall probability value (having taken into account the determined degree of validity of the machine-generated reply) satisfies the predetermined condition (e.g., the overall probability value is greater than the threshold value of 0). Thus, based on the overall probability value, it is predicted that human intervention will improve the likelihood of a positive outcome for the customer 124.

In other embodiments, the method proceeds from step 216 to step 218 when the prediction engine 150 determines that the live chat option is not to be made available. For example, the overall probability value (having taken into account the determined degree of validity of the machine-generated reply) does not satisfy the predetermined condition (e.g., the overall probability value is less than or equal to the threshold value of 0). Thus, based on the overall probability value, it is predicted that human intervention will not improve the likelihood of a positive outcome for the customer 124.

In step 218, the method displays the chatbot reply on the customer support interface 122 without making the live chat option available. For example, the live chat option continues to be withheld from the customer 124 after a first interaction with the chatbot (e.g., first query-reply pair). The method returns to step 210 after displaying the chatbot reply on the customer support interface 122. For example, the method continues to generate a reply (without human intervention) responsive to each of the customer's subsequent input queries on the customer support interface 122, and use each of the customer's real-time interaction with the chatbot as a feature data for the prediction engine 150 to determine at each interaction an updated overall probability value that human intervention will improve the likelihood of a positive outcome for the customer 124.

It is contemplated that the customer's input query may be resolved by the chatbot without requiring the assistance of a human agent 134, or the customer 124 may abandon the chat session before the live chat option is made available through the rule-based system 152 or prediction engine 150. Therefore, in some embodiments, the outcomes of the chat session and the chat transcripts of the chat session may be stored as customer classification data in the historical chat database 144. For example, the customer classification data can include, but is not limited to, a determination on whether the customer's query was resolved by, a determination on whether the chat session was abandoned without the live chat option being made available, customer feedback on the interaction with the chatbot and/or human agent 134, human agent feedback on the customer (e.g., input query, behaviour, etc.), or a combination thereof). The acquired customer classification data can then be used to train the prediction engine (e.g., the uplift model) to make better predictions and dynamically adapt the prediction engine to the customers' needs which can change over time.

As described above, the present invention is configured to address the customer's query using the more cost effective chatbot and conserve the limited human agent 134 resource until it is predicted that providing the live chat option will improve the likelihood of a positive outcome for the customer. In other words, the live chat option is selectively presented to only customers when it has been determined that they will likely benefit the most from engaging with a human agent 134. In this way, the allocation of available human agents is optimized and the deflection rate of the chatbot is improved. The present invention thus advantageously strikes a balance between increasing deflection rate and increasing customer satisfaction by running the prediction engine during the chat session to monitor the customer's interaction with the chatbot and dynamically determine the timing of when the live chat option should be offered to the customer (e.g., when it is predicted that human intervention can likely improve the outcome for the customer).

FIGS. 3a-3c show an example of a chat session displayed on a customer support interface 300 according to certain embodiments. The chat session and the customer support interface 300 are explained in conjunction with the system 100 and method 200 as described earlier through the previous figures of the disclosure and same or similar processes and elements may not be described in detail. In particular, FIGS. 3a-3c show an exemplary illustration of a customer support interface 300 that can be presented on the display screen of a customer device 120 during some implementations of the system 100 described in FIG. 1 and the method described in FIGS. 2a-2c.

In some embodiments, the customer support interface 300 includes an active text-based communication 302 area and a message input field (not shown). Messages received at the customer support interface 300 can be displayed in the active text-based communication area 302 (hereinafter “communication area”). In some embodiments, the communication area 302 displays a conversational dialog between a customer 124 and the chatbot of an e-commerce platform in real-time. For example, the customer 124 and the chatbot can exchange individual messages, where the individual messages are collectively considered the “conversation dialog”. The messages are, for example, presented in a text bubble. Other types of message containers can also be used to present the messages.

In an exemplary implementation of the system 100 and the method described in FIGS. 2a-2c, FIG. 3a shows the customer support interface 300 from the customer's viewpoint. As shown, the chatbot may generate and display a welcome message 342 in the communication area 302 to indicate the start of the chat session. For example, the welcome message 342 is displayed when the customer 124 selects a chatbot icon on a webpage of the e-commerce platform.

In some embodiments, the customer support interface 300 does not make available a live chat option at the start of the chat session. For example, the rule-based system 152 was executed prior to generating the welcome message 342 and has determined that the live chat option is not to be made available to the customer 124 at the start of the chat session. A live chat option is an option to have a live chat with a human agent 134. In some embodiments, the customer support interface 300 is not configured with a dedicated live chat button and the live chat option is only selectively offered by way of a chatbot message. In alternative embodiments, the customer support interface 300 may be configured to include a dedicated live chat button, which is disabled (e.g., the button is greyed out to indicate that it is in an inoperative state), or visually hidden, at the start of the chat session. In this exemplary implementation, the live chat option is only selectively offered by way of a chatbot message. Since no live chat option is presented within the welcome message 342, the customer 124 is compelled to interact with the chatbot.

FIG. 3b illustrates the customer support interface 300 receiving a first query 362 from the customer 124. The customer may submit a query to the chatbot using any appropriate technique, such as typing or speaking. For example, the query can be submitted as a text message or an audio of the customer 124 speaking the message. Where the customer 124 speaks a message to the customer device 120, speech recognition may be performed by the customer device 120, or by another component of the system 100, to translate the customer's spoken words into text.

The chatbot receives the customer's first query 362 and automatically processes the query 362 to determine a reply to the first reply without the involvement of a human agent 134. For example, the chatbot performs semantic processing on the text of the customer query to understand the meaning of the query, and then automatically generates a reply for display on the customer support interface 300. In FIG. 3b, the chatbot has processed the first query 362 received from the customer 124, determined that the intent of the first message relates to the status of a particular order (e.g., order #123) associated to the customer 124, and generated a first reply 344 that indicates the current status of the particular order.

After generating the first reply 344, the chatbot updates a chatbot interaction counter on the automated chatbot system 146 and communicates with the rule-based system 152. For example, the chatbot can cause the rule-based system 152 to be executed during the chat session to determine whether or not the counter value of the chatbot interaction counter has reached (e.g., is equal to or more than) the interaction threshold value. In FIG. 3b, the rule-based system 152 has determined that the counter value of the chatbot interaction counter has not reached the interaction threshold value. Thereafter, the chatbot acquires a first input data set and feeds the first input data set to the prediction engine 150. The first input data set includes the first reply 344 and the first query 362.

The prediction engine 150 processes the first input data set to determine a degree of validity of the first reply based on the first query (e.g., based on a sematic analysis of the query and the reply). The prediction engine 150 then uses the determined degree of validity of the first reply as a feature data alongside one or more other feature data in the first input data set as input data for further processing. For example, the prediction engine 150 utilizes an uplift model to further process the given input data, which includes the determined degree of validity of the first reply, and determine an overall probability that providing the customer 124 with the live chat option would improve the likelihood of a positive outcome for the customer 124. In FIG. 3b, the prediction engine 150 has determined the overall probability value to be less than or equal to 0 (e.g., the likelihood that the customer's first query will be resolved without human intervention is same as or greater than the likelihood that the customer's first query will be resolved with human intervention). Thus, the overall probability value does not satisfy a predetermined condition (e.g., exceed a threshold value of 0) for displaying the live chat option.

After determining the overall probability, the prediction engine 150 sends instructions to the chatbot (or the automated chatbot system 146) to continue withholding the live chat option. After receiving the instructions from the prediction engine 150, the chatbot then transmits the first reply 344 for display on the customer support interface 300 without making the live chat option available. Upon receiving the first reply 344, the customer support interface 300 displays the first reply 344 in the communication area 302.

FIG. 3c illustrates the customer support interface 300 displaying a second query 364 received from the customer 124. The chatbot automatically processes the second query 364 to determine a second reply to the second query 364 without the involvement of a human agent 134. In FIG. 3c, the chatbot has processed the second query 364 received from the customer 124, determined that the intent of the second query 364 is to disagree (or dispute) with the machine-generated first reply 344, and generated a second reply 346 that includes presenting one or more suggested actions that the customer 124 can take.

After generating the second reply 346, the chatbot updates the chatbot interaction counter on the automated chatbot system 146 and communicates with the rule-based system 152. For example, the rule-based system is executed to determine whether or not the updated counter value of the chatbot interaction counter has reached the interaction threshold value. In FIG. 3c, the rule-based system 152 has determined that the counter value of the chatbot interaction counter has not reached the interaction threshold value. Thereafter, the chatbot acquires a second input data set and feeds the second input data set to the prediction engine 150. The second input data set includes the second reply 346 and the second query 364.

The prediction engine 150 processes the second input data set to determine a degree of validity of the second reply based on the second query. The prediction engine 150 then uses the determined degree of validity of the second reply as a feature data alongside one or more other feature data in the second input data set as input data for further processing. For example, the prediction engine 150 utilizes the uplift model to further process the given input data, which include the determined degree of validity of the second reply, and determine an overall probability that providing the customer 124 with the live chat option would improve the likelihood of a positive outcome for the customer 124. In FIG. 3c, the prediction engine 150 has determined the overall probability value to be greater than 0 (e.g., the likelihood that the customer's second query will be resolved with human intervention is greater than the likelihood that the customer's second query will be resolved without human intervention). Thus, the overall probability value satisfies the predetermined condition (e.g., exceed a threshold value of 0) for displaying the live chat option.

After determining the overall probability, the prediction engine 150 sends instructions to the chatbot (or the automated chatbot system 146) to make the live chat option available. After receiving the instructions from the prediction engine 150, the chatbot then transmits the second reply 346, together with a live chat option 360, to the customer support interface 300. Upon receiving the second reply 346 and the live chat option 360, the customer support interface 300 displays the second reply 346 and the live chat option 360 in the communication area 302. As shown in FIG. 3c, the live chat option 360 may be displayed as a selectable interface element within the text bubble containing the second reply 346. For example, the live chat option 360 is displayed at the same time as the second reply and forms part of the second reply 346. Alternatively, the second reply 346 can be displayed at different time point from the live chat option 360 (e.g., the live chat option 360 may be displayed in a separate text bubble from the text bubble containing the second reply). For example, the second reply 346 can be displayed first and the live chat option 360 can be displayed after a delay period from the time the second reply 346 is displayed.

In an alternative implementation, if the live chat option is configured as a selectable interface element occupying a dedicated position (not shown) on the customer support interface 300, and the live chat option was made unavailable at the start of the chat session by visually hiding the selectable interface element, or by disabling the selectable interface element, the live chat option can be made available by revealing or enabling the selectable interface element for selection by the customer 124 when or after the second reply 346 is displayed.

As described above, the present invention is configured to address the customer's 124 query using the more cost effective chatbot and conserve the limited human agent 134 resource until it is predicted that providing the live chat option 360 will improve the likelihood of a positive outcome for the customer. In other words, the live chat option 360 is selectively presented to only customers 124 when it has been determined that they will likely benefit the most from engaging with a human agent 134. In this way, the allocation of available human agents 134 is optimized and the deflection rate of the chatbot is improved. The present invention thus advantageously strikes a balance between increasing deflection rate and increasing customer satisfaction by running the prediction engine during the chat session to monitor the customer's interaction with the chatbot and dynamically determine the timing of when the live chat option 360 should be offered to the customer (e.g., when it is predicted that human intervention can likely improve the outcome for the customer).

The present methodologies described herein are fully intended to be operable on a variety of devices or systems. Any hardware platform suitable for performing the methodologies described here is suitable for use with the invention. Unless specifically stated otherwise, and as apparent from the following, it will be appreciated that throughout the present specification, discussions utilizing terms such as “receiving”, “identifying”, ‘initiating”, “tagging”, “transmitting”, “running”, “incrementing”, “determining”, “assigning”, “approving”, “selecting”, “sending”, “calculating”, “analysing”, “replacing”, “generating”, “initializing”, “outputting”, “training” or the like, refer to the action and processes of a computer system, or similar electronic device, that manipulates and transforms data represented as physical quantities within the computer system into other data similarly represented as physical quantities within the computer system or other information storage, transmission or display devices.

In the application, unless specified otherwise, the terms “comprising”, “comprise”, and grammatical variants thereof, intended to represent “open” or “inclusive” language such that they include recited elements but also permit inclusion of additional, non-explicitly recited elements.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

What is claimed is:

1. A method for implementing a customer support interface, comprising:
generating the customer support interface for a customer to engage in a chat session with a chatbot, wherein an option to engage in a chat session with a human agent is made unavailable on the customer support interface;
receiving, by the chatbot, a first query from the customer;
determining, by the chatbot, a first reply to the first query and generating the first reply for display on the customer support interface;
after the first reply is generated, determining, using a prediction engine, an overall probability value that providing the customer with the option to engage in a chat session with a human agent would improve a likelihood of a positive outcome for the customer;
determining whether the overall probability value satisfies a predetermined condition; and
in response to determining that the overall probability value satisfies a predetermined condition, making available on the customer support interface a selectable interface element representing the option to engage in a chat session with a human agent, wherein selecting the selectable interface element transfers the customer from the chat session with the chatbot to the chat session with the human agent.

2. The method of claim 1, wherein determining the overall probability value that providing the customer with the option to engage in a chat session with the human agent would improve the likelihood of a positive outcome for the customer comprises:
using the prediction engine to analyse one or more customer-associated feature data and calculating a first and a second conditional probability value, wherein
the first conditional probability value is indicative of the likelihood of the positive outcome for the customer with human intervention, and
the second conditional probability value is indicative of the likelihood of the positive outcome for the customer without human intervention; and
calculating the overall probability value by subtracting the second conditional probability value from the first conditional probability value.

3. The method of claim 2, wherein analysing the one or more customer-associated feature data comprises analysing the first reply to determine a degree of validity of the first reply based on the first query.

4. The method of claim 1, wherein the prediction engine implements an uplift model to determine the overall probability value.

5. The method of claim 1, wherein determining whether the overall probability value satisfies a predetermined condition comprises determining whether the overall probability value is greater than a threshold value.

6. The method of claim 5, wherein the option to engage in a chat session with a human agent remains unavailable to the customer if the overall probability value is not greater than the threshold value.

7. The method of claim 1, wherein the option to engage in a chat session with a human agent is made unavailable on the customer support interface by visually hiding the selectable interface element from the customer.

8. The method of any one of claims 1-6, wherein the option to engage in a chat session with a human agent is made unavailable on the customer support interface by disabling the selectable interface element.

9. The method of claim 1, wherein the first reply is displayed and the selectable interface element is concurrently made available on the customer support interface, or
the selectable interface element is made available on the customer support interface after or soon after the first reply is displayed.

10. The method of claim 1, wherein the selectable interface element is made available as part of the first reply.

11. The method of claim 1, further comprising:
executing a rule-based system prior to a start of the chat session; and
determining, using the rule-based system, that the option to engage in a chat session with a human agent is to be made unavailable on the customer support interface at the start of the chat session.

12. The method of claim 1, further comprising:
executing a rule-based system after the first reply is generated, wherein the rule-based system comprises a condition that depends on a number of interactions between the customer and the chatbot in the chat session.

13. The method of claim 12, wherein the rule-based system acquires data from a customer account database and/or a historical chat database.

14. An apparatus for comprising:
at least one memory; and
at least one processor coupled to the at least one memory, the at least one processor configured to perform operations for:
generating a customer support interface for a customer to engage in a chat session with a chatbot, wherein an option to engage in a chat session with a human agent is made unavailable on the customer support interface;
receiving, by the chatbot, a first query from the customer;
determining, by the chatbot, a first reply to the first query and generating the first reply for display on the customer support interface;
after the first reply is generated, determining, using a prediction engine, an overall probability value that providing the customer with the option to engage in a chat session with a human agent would improve a likelihood of a positive outcome for the customer;
determining whether the overall probability value satisfies a predetermined condition; and
in response to determining that the overall probability value satisfies a predetermined condition, making available on the customer support interface a selectable interface element representing the option to engage in a chat session with a human agent, wherein selecting the selectable interface element transfers the customer from the chat session with the chatbot to the chat session with the human agent.

15. The apparatus of claim 14, wherein to determine the overall probability value that providing the customer with the option to engage in a chat session with the human agent would improve the likelihood of a positive outcome for the customer comprises:
using the prediction engine to analyse one or more customer-associated feature data and calculating a first and a second conditional probability value, wherein
the first conditional probability value is indicative of the likelihood of the positive outcome for the customer with human intervention, and
the second conditional probability value is indicative of the likelihood of the positive outcome for the customer without human intervention; and
calculating the overall probability value by subtracting the second conditional probability value from the first conditional probability value.

16. The apparatus of claim 15, wherein analysing the one or more customer-associated feature data comprises analysing the first reply to determine a degree of validity of the first reply based on the first query.

17. The apparatus of claim 14, wherein the prediction engine implements an uplift model to determine the overall probability value.

18. The apparatus of claim 14, wherein determining whether the overall probability value satisfies a predetermined condition comprises determining whether the overall probability value is greater than a threshold value.

19. The apparatus of claim 18, wherein the option to engage in a chat session with a human agent remains unavailable to the customer if the overall probability value is not greater than the threshold value.

20. A non-transitory computer-readable storage medium comprising at least one instruction for causing a computer or processor implement operations for:
generating a customer support interface for a customer to engage in a chat session with a chatbot, wherein an option to engage in a chat session with a human agent is made unavailable on the customer support interface;
receiving, by the chatbot, a first query from the customer;
determining, by the chatbot, a first reply to the first query and generating the first reply for display on the customer support interface;
after the first reply is generated, determining, using a prediction engine, an overall probability value that providing the customer with the option to engage in a chat session with a human agent would improve a likelihood of a positive outcome for the customer;
determining whether the overall probability value satisfies a predetermined condition; and
in response to determining that the overall probability value satisfies a predetermined condition, making available on the customer support interface a selectable interface element representing the option to engage in a chat session with a human agent, wherein selecting the selectable interface element transfers the customer from the chat session with the chatbot to the chat session with the human agent.
